(19) United States
(12) Patent Application Publication
(10) Pub. No.: US 2013/0326369 A1
(43) Pub. Date: Dec. 5, 2013

(54) System and Method For Analyzing User Generated Choices and Trends

(71) Applicant: Phillip Buchanon, Miami, FL (US)

(72) Inventor: Phillip Buchanon, Miami, FL (US)

(73) Assignee: Phillip Buchanon Technologies, Miami, FL (US)

(21) Appl. No.: 13/732,034

(22) Filed: Dec. 31, 2012

Related U.S. Application Data
(60) Provisional application No. 61/653,998, filed on May 31, 2012.

(51) Int. Cl. H04L 29/08

(52) U.S. Cl. CPC H04L 67/22
USPC 715/753

(57) ABSTRACT

This disclosure teaches a system and method that allows users to share their views in the form of selecting their preference among choices, without disclosing personal information unless they choose. Furthermore, this disclosure teaches a system and method that allows for a user to share and compare his or her views and measure them against other users. This disclosure may also be run in conjunction with other social networking internet sites, such as an application on Facebook, or on its own.

### CROSS-REFERENCE TO RELATED APPLICATION

The present application is related to and claims the benefit of U.S. Provisional Application No. 61/653,998 filed on May 31, 2012 the entire contents of which being incorporated herein by reference.

### FIELD OF THE INVENTION

The present invention relates generally to the field of social networking and more particularly to identifying trends based on end users choices.

### BACKGROUND OF THE PRIOR ART

There are variety of social networking Internet sites also known as social networks such as Facebook, MySpace, Twitter, Linkedln, Reddit, Digg, Pinterest and Tumblr. These social network sites allow individuals to connect over the internet for a variety purposes from business networking to dating. Individual users provide details about themselves they would like to share with the other users of the social network.

Many individual users are open about their personal lives which allows for the social network owners to use targeted advertising in order to develop streams of revenue. For others social networking creates privacy concerns because although users do not mind sharing personal information with their self-selected online “friends”, many users are uneasy about sharing personal information with advertisers.

Another drawback of existing social networks is that hackers may sometimes gain access to an existing account of a legitimate user. With the unauthorized access, the hacker can use personal information in a manner that the legitimate user would find abhorrent.

End users sometimes also have the desire to create their own platform instead of just using the template provided by the social networking site content provider.

There is a need in the industry for an application that is easy to use, since most users are not programmers, but flexible enough to allow end user's creativity to shine through.

It would be desirable to have an application that lets users share their opinions with the option of being identified or remaining anonymous. It would also be desirable to have a platform that allows users to identify opinions of like-minded people based on any number common identifiers. It is would also be desire to allow users to create their own choices and customize the results based on certain group criteria.

### SUMMARY

This disclosure teaches a system and method that allows users to share their views without disclosing personal information unless they choose. Furthermore, this disclosure teaches a system and method that allows for a user to share and compare his or her views and measure them against other users. This disclosure may also be run in conjunction with other social networking internet sites, such as an application on Facebook, or on its own.

In one embodiment of the disclosure a web based application that displays categorized options based on user generated content comprising an interface configured to display options to an end user, a tracking module configured to link user generated results derived from the options to a unique identifier associated with an associated end user, and a relation module configured to compare said results from a plurality of end users.

In another embodiment of the disclosure the relation module is further configured to rank end users based at least in part on the relationship that their results are matched with a majority other associated end users.

In another embodiment the interface is displayed on a smart phone or a tablet device.

In another embodiment the relation module is further configured to process and communicate trends that are based at least in part on geography and/or pervious results.

In another embodiment there is a management server configured to communicate trends with at least one other associated social networking sites and a controller module configured to restrict and allow access to results information.

In another yet embodiment there is a method of providing a social networking interface comprising linking a user to a unique identifier, displaying a plurality of options separated into categories where said options are generated by said user on an interface and derive a result based at least in part on user preference, storing said plurality of options and said results and providing a tracking system configured to link said options and said results to said unique identifier such as an email address.

Another embodiment includes the steps of identifying trends based on said results and displaying said trends on said interface.

In another embodiment the method includes displaying the options along with an audio file or a video file.

In yet another embodiment the method further comprises identifying that a plurality of said results of said unique identifier that has a predetermined level of similarity to a plurality of said results of a second unique identifier.

In yet another embodiment the disclosure includes a social networking application comprising a first interface that enables a first user create a plurality of options for a social networking site, a second interface configured to selectably present said options to a second user, a means for enabling the second user to communicate said selection from the option to a controller and a relation module configured to map and relate said selections to other associated users' selections.

In another embodiment the social networking application includes the relation module, but it is configured to identify trends based on the second user's information.

In another embodiment the trends are based on end users with similar geographic information and the trends are based on users previously selected options while including a controller configured restrict the flow of information based on privacy settings.

### BRIEF DESCRIPTION OF THE DRAWINGS

FIG. 1 illustrates an exemplary architecture for the system that is in accordance with embodiments of the present disclosure;

FIG. 2 illustrates an exemplary end user interface that is consistent with the principles of the present disclosure;

FIG. 3 illustrates an another exemplary end user interface that is consistent with the principles of the present disclosure;

FIG. 4 illustrates a flow diagram of the method that is in accordance with one exemplary embodiment of the present disclosure.

### DETAILED DESCRIPTION OF THE DRAWINGS

The following is a description of some of the embodiments as they relate to the field of social networking. Other embodiments of the invention will be apparent to those skilled in the art from consideration of the specification and practice of the disclosure that is disclosed herein. It is intended that the specification and examples be considered as exemplary only, with a true scope and spirit of the disclosure being indicated by the claims.

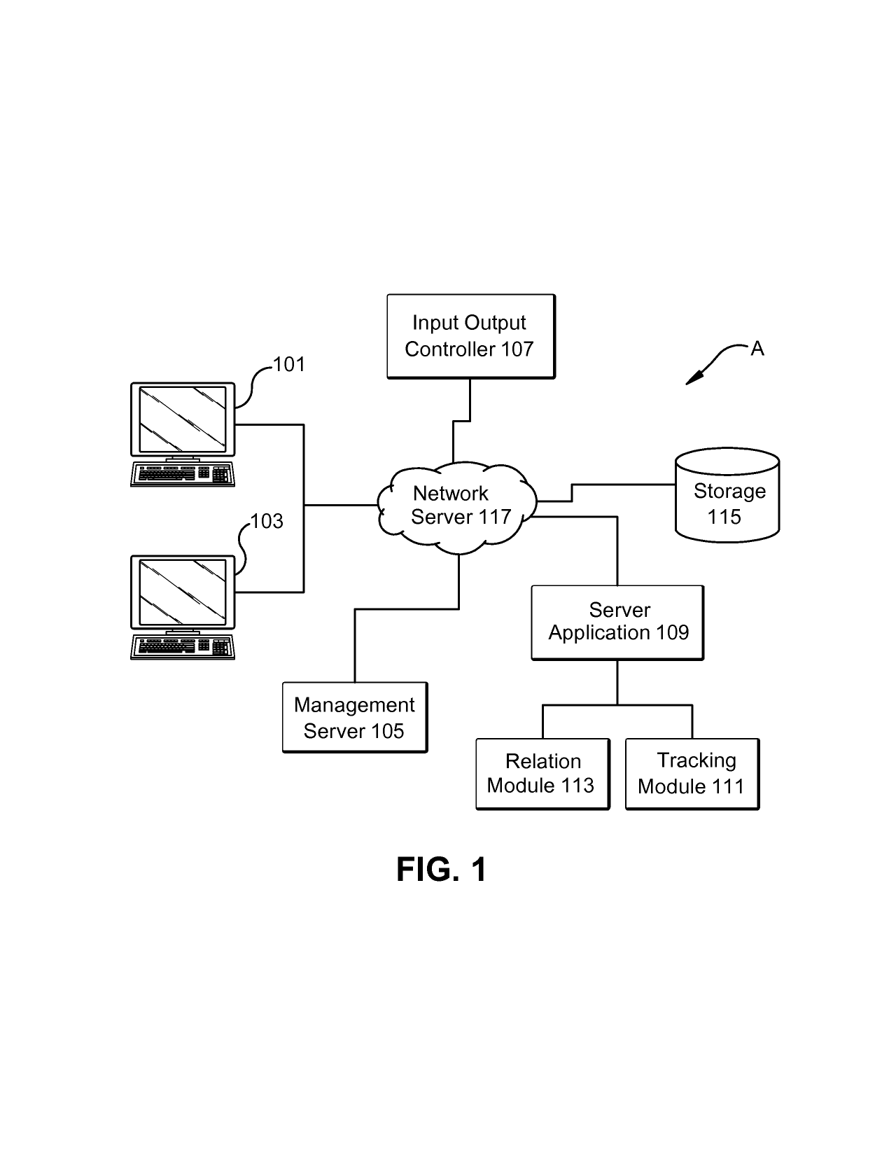

FIG. 1 illustrates an exemplary architecture 1 for the system that is in accordance with embodiments of the present disclosure. It should be understood that this is but one configuration of the architecture and other architectures may be implemented and still fall within the scope of the claims.

This architecture A includes a plurality of interfaces 101, 103 a management server 105, an input/output controller 107, an application server 109, a tracking module 111, relation module 113, and storage 115. All of these components are in communication with a network 117.

The interface 101 may be viewed on a computer, a tablet, a cell phone, a smart phone an MP3 player, a dedicated application device or any other electronic device or platform that allows for an associated end user to connect to the management server 105 and/or application server 109. In one embodiment, the interface 101 platform is able to connect to the internet which serves as a network 117 for connectivity. In another embodiment, the interface 101 stores the data necessary to access and run the application and communicates the data only after connectivity to the network 117 is established. In yet another embodiment, the application server 109 is in communication with the interface 101 directly, and the interface 101 platform is a dedicated device for this application.

The management server 105 may serve to host a variety of internet based programs. This may include other social networking sites, for example. The management server 105 may also facilitate communication with other associated end users.

The input/output controller 107 serves as a means to restrict and allow communication through the network 117. It may be desirable to allow access to only certain pieces of information to the network 117. For example, in one embodiment, the user may prefer if only location information were presented to the network 117. In another example, it may be desirable if only a unique identifier were used to link the associated user to the data. In this form, the associated user may remain anonymous to the outside world, or maybe just anonymous to a certain group of users. The user may also want to share some or all personal information in his or her profile. The profile may also be shared with other social networks.

The server application 109 provides the logic for analyzing and managing the operations of the overall system. Server application 109 may be written in a variety of programming languages, such as C, C++, Java, etc. The server application 109 may be running a social networking site in the background in which may host the operations. In another embodiment, the server application 109 is managing the operations independently.

For example, one responsibility of server application 109 may be managing the identities of users. An associated end user may even have multiple identities that he or she uses for various online services and social networks. Each of these identities may include its own unique identifier so that each end user may be tracked only once.

In one embodiment, in order to track the various users, the server application 109 may assign each user a unique identifier, such as a numeric identifier. The server application 109 may then utilize this unique identifier with the identity resources (i.e., email address, account names, screen names, etc.) used by services to identify a person. In some embodiments, the server application 109 generates a graph to each of the user's social networks. The tracking module 111 may be implemented in order to facilitate this function. The tacking module 111 may also be used to track statistics. These statistics may include a basic count in which to measure usage of the network. The tracking module 111 may also be used to track the number of comparisons or match-ups drafted by unique identifier. This may be used to rank end users or acknowledge milestones reached by an end user. A ranking system may be established and based on wide number of criteria. For example, it may be based on the number of times, or percentage of times, an end user votes for an option that is in the majority, or chooses the same option as more than half of other end users. It may be used to count the number of times, or percentage of times, an end user is in the minority. These concepts may be identified and grouped as trends and are further explained throughout this disclosure.

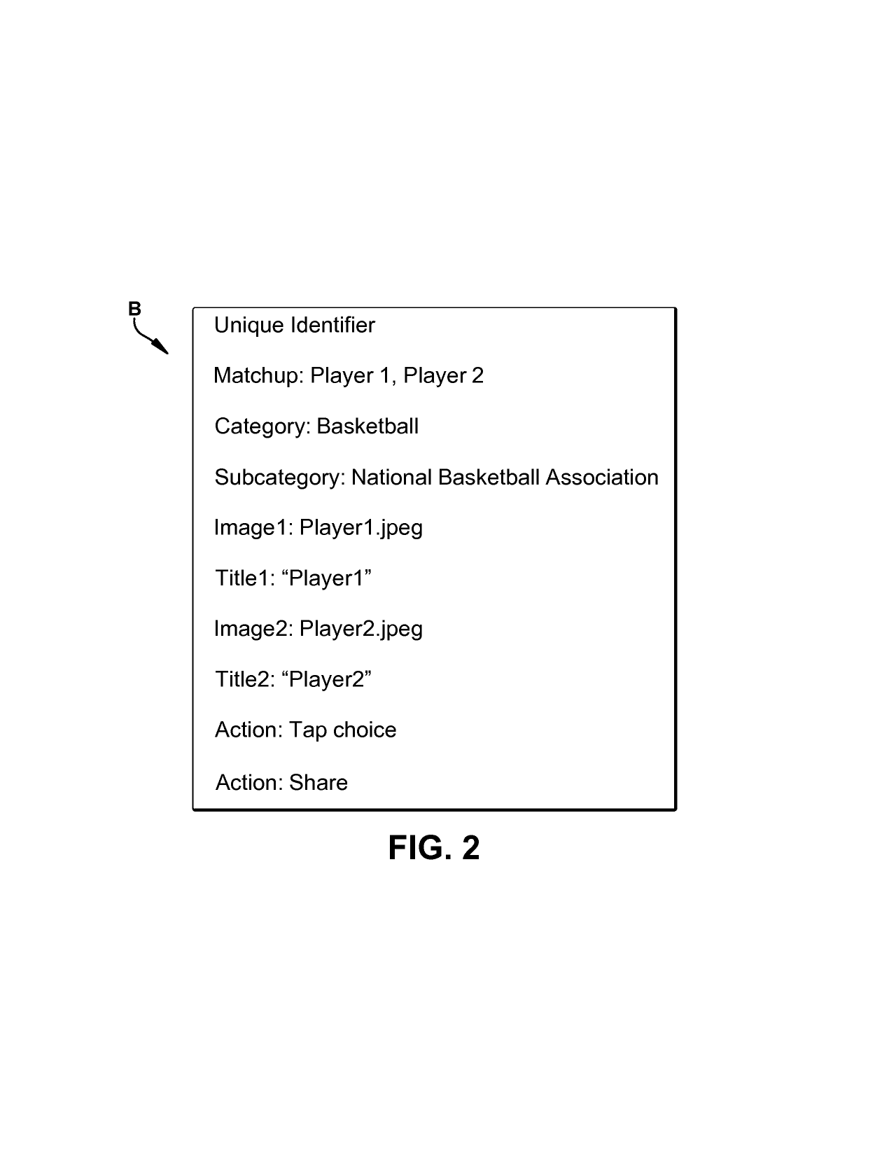

The relation module 113 may also be implemented to weigh similarities and differences between unique identifiers, such results (FIG. 2) selected, options (FIG. 2) presented, etc. The relation module 113 may map these selections back to the unique identifier and display what that end user who selected this has chosen as a result. This information e.g. the result or the user who selected it, may be available or restricted depending on the functionality of the input/output controller 107.

Now referring to FIG. 2 which shows an interface for an end user to create a match-up consistent with this disclosure. In this embodiment an associated end user creates a match-up between two options, player 1 and player 2. An associated end user selects a category which may be from a number of choices or self-generated, along with an optional subcategory. The user may also select image to accompany the choice. The user may also choose to select a sound file such as an .mp3 or way file for example, to accompany the choice. A user may also choose to post a video file to accompany the choice.

The user may select to post the match-up or share with a select group of users. The tracking module 111 (FIG. 1) will then track the match-up and identify trends based on the criteria. For the purposes of this disclosure a trend is any way that a user can be grouped with another user, something that two or more users have in common. Trends may be based on a predetermined number of selections, for any number of populations. A trend may be a user's gender, for example. But a trend may also parse results based on certain zip code or other geographic information, age group, group of associated individuals, etc. Any information that the user volunteered or allowed to be derived may be criteria in which to base a trend, including previous selections.

At times it may be useful to identify that one or more end users that have similar results to other end users. This level of similarity may be based on any number of predetermined criteria. The results and trends can be stored in storage 115 and/or communicated to the community of like-minded users. If privacy settings permit, these results may communicated to other users, or possibly marketing analysts. This information, may include no personal information, a little personal but not sensitive information, or a lot of personal information depending on the purpose and contractual agreements with the users and the entity seeking the information.

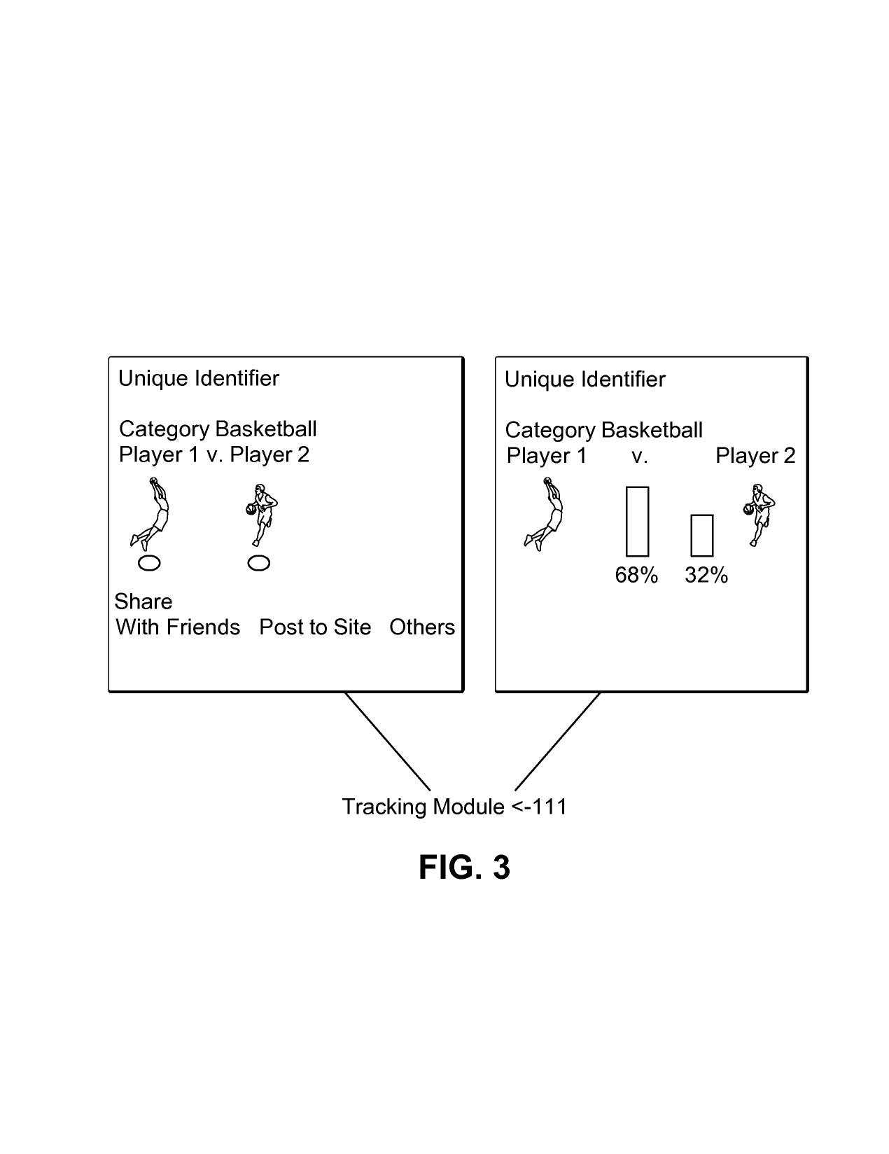

Now referring to FIG. 3 which shows another interface. This embodiment is representing a match-up which may have been drafted by another end user. The options are displayed via the interface 101 and the end user chooses one of the plurality of options. The results interface D tracks the number of times a selected option was chosen by the population chosen. This information may be tracked by the tracking module 111 working in conjunction with the input/output controller 107.

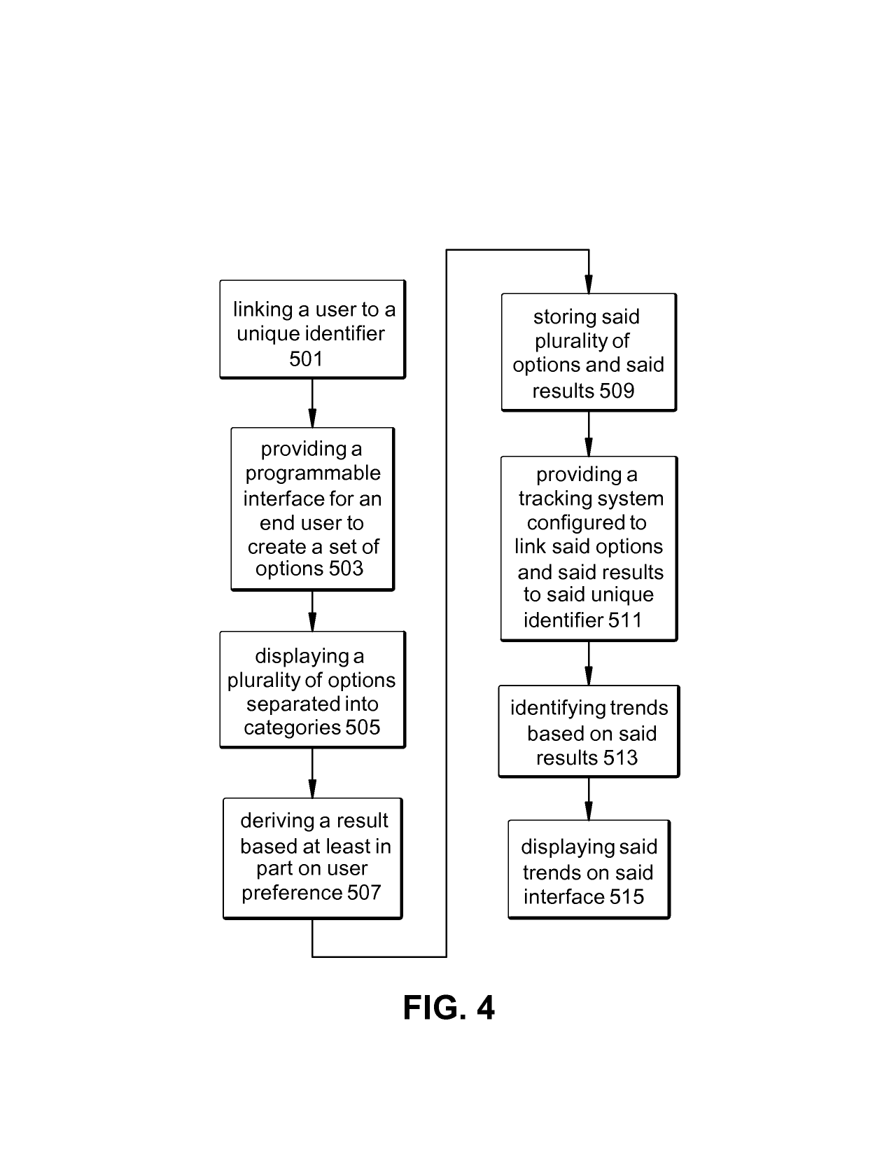

FIG. 4 illustrates a flow diagram of the method that is in accordance with one exemplary embodiment of the present disclosure. The steps of the method are outlined herein, however each of the steps may include other substeps which will continue to fall within the scope of the claims. The first step in the method includes linking a user to a unique identifier 501. The unique identifier may be a number, a screen name, or any number identifiers that is unique to the user. The screen name may be assigned or chosen be the associated end user.

The next step includes providing a programmable interface for an end user to create a set of options 503. This allows for the associated end user to create his or her own match-up.

The next step includes displaying a plurality of options separated into categories 505. This will allow for the associated end user to choose an option based on the choice presented.

The next step includes deriving a result based at least in part on user preference 507. The user may click, touch, or tap one of the plurality of choices presented. The next step includes storing said plurality of options and said results 509. The next step includes providing a tracking system configured to link said options and said results to said unique identifier 511. The next step includes identifying trends based on said results 513. The last listed step includes displaying said trends on said interface 515. The trends may be based on predetermined number users, which may include the users that have a trait in common. For example, a trend may be based on users of a different social media website. It could also include users only in a certain geographic location, or even users that choose the same result on previous matchup. The trends may also be tracked for any one user. The user may then be ranked according to derived statistics against other sets of users. These statistics and in turn rankings may be based on the trends.

It will be appreciated to those skilled in the art that the preceding examples and embodiments are exemplary and not limiting to the scope of the disclosure. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

I claim:

1. A web based application that displays categorized options based on user generated content comprising:
an interface configured to display options to an associated end user;
a tracking module configured to link user generated results derived from said options to a unique identifier associated with an associated end user; and
a relation module configured to compare said results from a plurality of end users.

2. The application according to claim 1, wherein said relation module is further configured to rank end users based at least in part on the relationship that their results are matched with a majority other associated end users.

3. The application according to claim 1, wherein said interface is displayed on a smart phone.

4. The application according to claim 1, wherein said interface is displayed on a tablet device.

5. The application according to claim 1 wherein said relation module is further configured to process arid communicate trends.

6. The application according to claim 5, wherein trends are based at least in part on geography.

7. The application according to claim 5, wherein trends are based at least in part on previous results.

8. The application according to claim 1, further comprising a management server configured to communicate trends with at least one other associated social networking sites.

9. The application according to claim 1, further comprising a controller module configured to restrict and allow access to results information.

10. A method of providing a social networking interface comprising:
linking a user to a unique identifier;
displaying a plurality of options separated into categories where said options are generated by said user on an interface and derive a result based at least in part on user preference;
storing said plurality of options and said results; and
providing a tracking system configured to link said options and said results to said unique identifier.

11. The method according to claim 10 further comprising:
identifying trends based on said results; and
displaying said trends on said interface.

12. The method according to claim 11 wherein said unique identifier is an e-mail address.

13. The method according to claim 11 wherein said options are displayed with an audio file.

14. The method according to claim 11 wherein said options are displayed with a video file.

15. The method according to claim 11 further comprising identifying that a plurality of said results of said unique identifier that has a predetermined level of similarity to a plurality of said results of a second unique identifier.

16. A social networking application comprising:
a first interface that enables a first user create a plurality of options for a social networking site;
a second interface configured to selectably present said options to a second user;
a means for enabling the second user to communicate said selection from said option to a controller; and
a relation module configured to map and relate said selections to other associated users' selections.

17. The social networking application according to claim 16 wherein said relation module is configured to identify trends based on the second users information.

18. The social networking application according to claim 16 wherein said trends are based on end users with similar geographic information.

19. The social networking application according to claim 16 wherein said trends are based on users previously selected options.

20. The social networking application according to claim 16 further comprising a controller configured restrict the flow of information based on privacy settings.
